(19) United States
(12) Patent Application Publication
(10) Pub. No.: US 2013/0099938 A1
(43) Pub. Date: Apr. 25, 2013

(54) SOFTWARE-DEFINED COMMUNICATION UNIT

(71) Applicants: Vladimir Borisov, Seneca, SC (US); Sudhir Thumaty, Clemson, SC (US)

(72) Inventors: Vladimir Borisov, Seneca, SC (US); Sudhir Thumaty, Clemson, SC (US)

(73) Assignee: ITRON, INC., Liberty Lake, WA (US)

(21) Appl. No.: 13/278,412

(22) Filed: Oct. 21, 2011

(51) Int. Cl. G08C 15/06; H04B 1/38

(52) U.S. Cl. 340/870.02; 375/219

(57) ABSTRACT

The presently disclosed subject matter relates to communications units. In some uses thereof, such communications units may be respectively associated with utility meters for use in an advanced metering system infrastructure. Present communications units have a medium-agnostic front end module and associated transmitting and receiving functionalities that are programmable to provide simultaneous reception and transmission using multiple protocols over different media and to change to a single protocol functionality upon reception of a valid signal on one of the monitored transmissions. The communications unit may be field programmable for known and previously undefined transmission protocols to provide a future proof device.

### FIELD OF THE SUBJECT MATTER

The presently disclosed subject matter relates to communications. More specifically, the presently disclosed subject matter relates to software defined medium-agnostic communication platform for use in Smart Grid applications.

### BACKGROUND OF THE SUBJECT MATTER

The continuous evolution of the numerous communication platforms, standards, and protocols associated with Smart Grid communications gives rise to serious concerns that the large Advanced Metering Infrastructure (AMI) and Smart Utility Networking (SUN) systems currently under deployment may become obsolete in the near future.

Generally, an Advanced Metering Infrastructure (AMI) may in some instances contain millions of metering devices distributed over a large geographical area. Such devices are configured to exchange messages including data, for example, utility consumption data, with a cluster of servers, such as including data metering collectors and network management servers. AMI's may in some instances be generally organized around autonomous systems headed by components such as cell relays, sometimes referred to as cell router. Each autonomous system is connected to servers that may be located at a utility home-office, for example, such as by way of a backhaul network.

Frequently, Smart Grid solutions must meet several types of non-homogenous use cases. In other words, for example, such solutions in some instances need preferably to provide for high density networks with devices installed in many and varied locations. Such locations may include outside, indoors, in basements, and in overhead spaces as well as in low density networks spread over long distances with non line-of-sight devices. Preferable solutions would be designed so as to take into consideration overall preferred latency, reliability, and cost performances.

In view of these known issues, it would be desirable to provide apparatuses and methodologies whereby communications units may be provided with long-term “future-proof” functionality. While various aspects and alternative embodiments may be known in the field of communications platforms, no one design has emerged that generally encompasses the above-referenced characteristics and other desirable features associated with communications technology as herein presented, particularly as relates to power line communications technologies.

### SUMMARY OF THE SUBJECT MATTER

In view of the recognized features encountered in the prior art and addressed by the presently disclosed subject matter, an improved methodology for providing universal communication units for use in various Smart Grid applications has been provided.

In accordance with one exemplary embodiment of the presently disclosed technology, a communications unit is provided that has a protocol-transparent front end module. Such exemplary front end module may include a multi-band antenna system, a radio frequency (RF) receiver, and an RF transmitter. Such an exemplary transceiver may couple the front end module to a baseband signal processor. The transceiver and signal processor may be configured to cooperate with the front end module to simultaneously listen for transmitted signals by using multiple different modulation techniques and to behave as a single protocol receiver once a transmitted valid signal is detected.

In certain embodiments, such an exemplary communications unit may further include a power line communications (PLC) module. In some of such embodiments, the transceiver and signal processor may be further configured to provide dual simultaneous concurrent RF and PLC communications.

In other present alternative embodiments, the transceiver and signal processor may be further configured to provide bridged communications between an RF network and a PLC network.

In yet other present alternative embodiments, the transceiver and signal processor may be configured to cooperate with the front end module to simultaneously listen for at least two different modulation techniques.

In still other variations of certain embodiments of the presently disclosed subject matter, the transceiver and baseband signal processor may be programmable whereby the receiver may be programmed to receive alternative additional transmission frequencies and modulation protocols. In selected such embodiments, the transceiver may be implemented in software with a digital I and Q interface.

Another present exemplary embodiment relates to an advanced metering system (AMS) including a collection engine, a plurality of endpoint devices each including a communications unit, and at least one network configured to provide communications between the collection engine and the plurality of endpoint devices. In such exemplary embodiments, the communications unit included with each endpoint device may be configured to simultaneously listen for signals transmitted using multiple different modulation techniques and to behave as a single protocol receiver once a valid signal is detected.

In variations of such alternative embodiments, the presently disclosed subject matter may also provide a second network and a power line communications (PLC) module associated with the communication unit.

In some of such alternative embodiments, the at least one network may be a radio frequency (RF) network, the second network may be configured for communications as a power line communication (PLC) network, and the communication unit may be further configured to provide dual simultaneous concurrent RF and PLC communications.

In selected of such alternative embodiments, the communication unit may be further configured to provide bridged communications between such an RF network and such PLC network. In particular variations of present embodiments, the communication unit may be programmable so that the receiver may be programmed to receive alternative additional transmission frequencies and modulation protocols.

Another present exemplary embodiment of the presently disclosed subject matter also relates to a utility meter including a housing having a base and a removable cover. Within the housing may be positioned a metrology circuit board mounted with a communications unit also mounted therein and coupled to the metrology circuit board. In such utility meters, the communications unit may correspond to a protocol-transparent front end module including a multi-band antenna system, a radio frequency (RF) receiver, and an RF transmitter, a transceiver coupled to the front end module, and a baseband signal processor coupled to the transceiver.

Utility meters constructed in accordance with such exemplary embodiments may provide the transceiver and signal processor as devices configured to cooperate with the front end module to simultaneously listen for transmitted signals by using multiple different modulation techniques and to behave as a single protocol receiver once a valid signal is detected. In certain of such alternative embodiments, the exemplary utility meter may also include a power line communications (PLC) module associated with the front end module in a manner such that the transceiver and signal processor may be further configured to provide dual simultaneous concurrent RF and PLC communications.

In particular alternative embodiments of the foregoing, the transceiver and signal processor may be further configured to provide bridged communications between an RF network and a PLC network, and in some instances to cooperate with the front end module to simultaneously listen for at least two different modulation techniques. In yet further alternative embodiments, the transceiver and baseband signal processor may be programmable whereby the receiver may be programmed to receive alternative additional transmission frequencies and modulation protocols.

Those of ordinary skill in the art will appreciate from the complete disclosure herewith that the presently disclosed subject matter equally pertains to both devices as well as corresponding and related improved methodologies. One presently disclosed exemplary embodiment in accordance with presently disclosed technology relates to a method, comprising simultaneously listening for signals transmitted using multiple different protocols; detecting a valid signal based received signals; and decoding and demodulating the received signal based on a detected valid signal. In some instances, detecting comprises detecting a valid preamble signal. All such aspects and embodiments (both apparatus and method-based) fall within the scope of the present disclosure. Although the disclosed materials has application in such as Smart Grid and AMI networks, and meshed networks, the concepts are equally applicable in more general communication networks which can benefit in a similar fashion as presently disclosed. In a utility industry setting, the nodes may include endpoints, meters, cellular relays, routers, transformers, substations, servers and head offices, for example. While techniques are described herein in the context of a utility network, the techniques are also applicable to other types of networks as well, such as, for example, telecommunications networks, sensor networks, and the like. In the context of other networks, nodes may include servers, computers, routers, switches, sensors, or any other device coupled to any type of network.

Additional details of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIG. 1 represents in block diagram format a schematic diagram of a universal communications unit in accordance with presently disclosed technology;

FIG. 2 illustrates a block diagram overview of an Advanced Metering System (AMS) in which software-defined communications units constructed in accordance with the presently disclosed subject matter may be employed;

FIG. 3 is a top isometric view of an exemplary utility meter employing a printed circuit board incorporating a software-defined communications unit in accordance with the presently disclosed technology; and

FIG. 4 is a flow chart illustrating an exemplary method by which the presently disclosed subject matter receives and decodes messages.

Repeat use of reference characters throughout the present specification and appended drawings is intended to represent same or analogous features, elements, or steps of the subject matter.

### DETAILED DESCRIPTION OF THE SUBJECT MATTER

As discussed in the Summary of the Subject Matter section, the presently disclosed subject matter relates to a universal communications unit such as for use in Smart Grid applications including communication units for Advanced Metering Infrastructure (AMI), Distribution Automation (DA), Smart Utility Networking (SUN), and other Smart Grid applications.

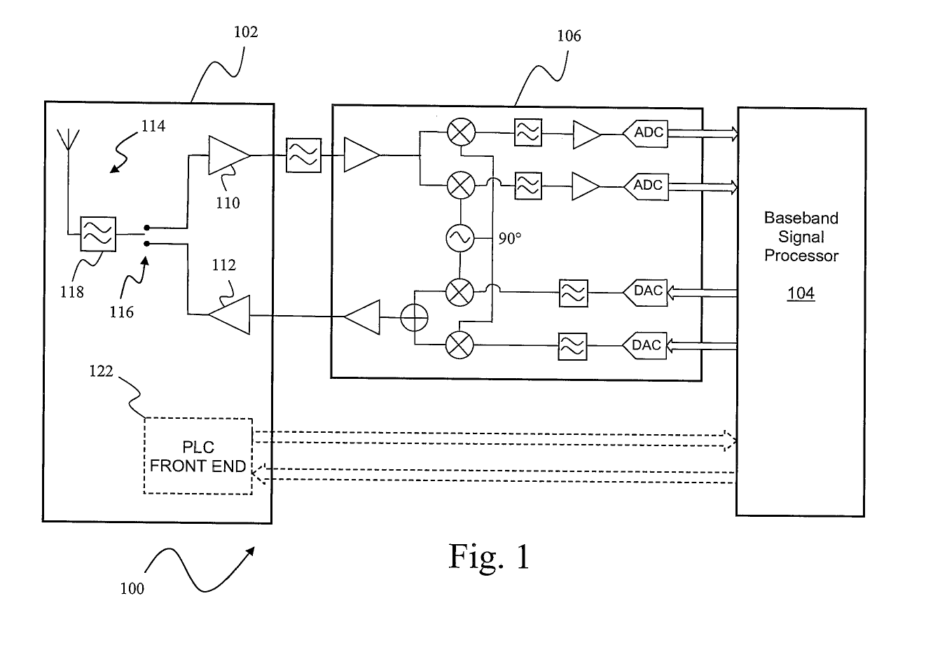

With initial reference to FIG. 1, there is illustrated a block and schematic diagram of a universal communications unit generally 100 in accordance with presently disclosed technology. As illustrated in FIG. 1, universal communications unit 100 includes a protocol-transparent front-end module 102 and a fully-reprogrammable digital base-band processor 104 coupled together by way of transceiver 106. Front-end module 102 corresponds to radio frequency (RF) receiver 110, RF transmitter 112, a multi-band antenna system 114, and an antenna switching device 116 alternatively coupling receiver 110 or transmitter 112 to antenna 114 by way of an optional filter 118. In certain embodiments, an AC line coupler providing a power line communications (PLC) front end 122 may also be included as a part of front-end module 102.

As is generally understood by those of ordinary skill in the art, antenna switching device 116 although presently illustrated as a mechanical switch configuration may, nevertheless, correspond to a number of different devices including, without limitation, mechanical contact type switching devices, duplexers, and/or solid state devices such as, but not limited to, tunnel diode switches.

Transceiver 106 and base-band processor 104 are configured to be fully compatible with multiple wireless and power line communications standards and protocols so that the receiver will be able to simultaneously listen to signals transmitted using multiple different modulation techniques. In an exemplary configuration, the receiver may be configured to listen to two different signals including high data rate signals transmitted in accordance with IEEE 802.15.4g standards including either orthogonal frequency-division multiplexing (OFDM) or offset quadrature phase-shift keying (OQPSK), a frequency-shift keying (FSK) modulated signal to provide legacy device support or 802.15.4g mandatory mode, and a specific low data rate modulation signal intended for hard-to-reach meters where a long range link is necessary. In selected embodiments, FSK operations may be at 50 kbps or 150 kbps with forward error correction (FEC) using a Non-Recursive and Non-Systematic Code (NRNSC) option. Once a valid preamble is detected, the presently disclosed subject matter is configured so that the receiver will behave, that is, operate as a single protocol receiver by fully demodulating and decoding the received packet corresponding to the valid preamble detected. In transmit mode, preferably only one protocol is supported at a time. In an exemplary configuration, the RF equipment here described may be designed to operate in the 902 MHz-928 MHz ISM band, although it is possible to provide for operation in other bands in place of or in addition to such particular exemplary ISM band.

As presently illustrated, transceiver 106 may correspond to an RF transceiver with a digital I and Q interface that may be implemented in software under control of, for example, a microprocessor or other similar device. Alternatively, other types of transceivers may also be provided as software-defined radios as well. Those of ordinary skill in the art will appreciate that corresponding hardware implementations are also possible, and are intended as within the scope of the presently disclosed subject matter.

With further reference to FIG. 1, it will be seen that power line communications (PLC) may also, in some embodiments, be provided for by the inclusion of a PLC front end 122 that may be directly coupled (shown by dotted lines in FIG. 1) to baseband signal processor 104. In an exemplary configuration, the PLC option, if implemented, may be based on the IEEE P1901.2 standard (based on G3 options) and configured to run concurrently with the RF protocols, as understood by those of ordinary skill in the art without further discussion. When provided, the PLC components of the presently disclosed subject matter may be designed to operate in a wide band from DC to 30 MHz.

By the foregoing exemplary combination of capabilities, such exemplary embodiment of the presently disclosed subject matter provides for communications functionalities in, for example, smart grid communication devices. Such devices include dual simultaneous concurrent Radio Frequency/Power Line Carrier Physical layer communications driven by a single or separate Medium Access Layer and a single smart network layer corresponding to either standard or proprietary configurations to manage efficient packet routing over as well as between both RF and Power Line Carrier media Implementation of such a system offers one exemplary solution to providing future-proofed communications units for developing systems.

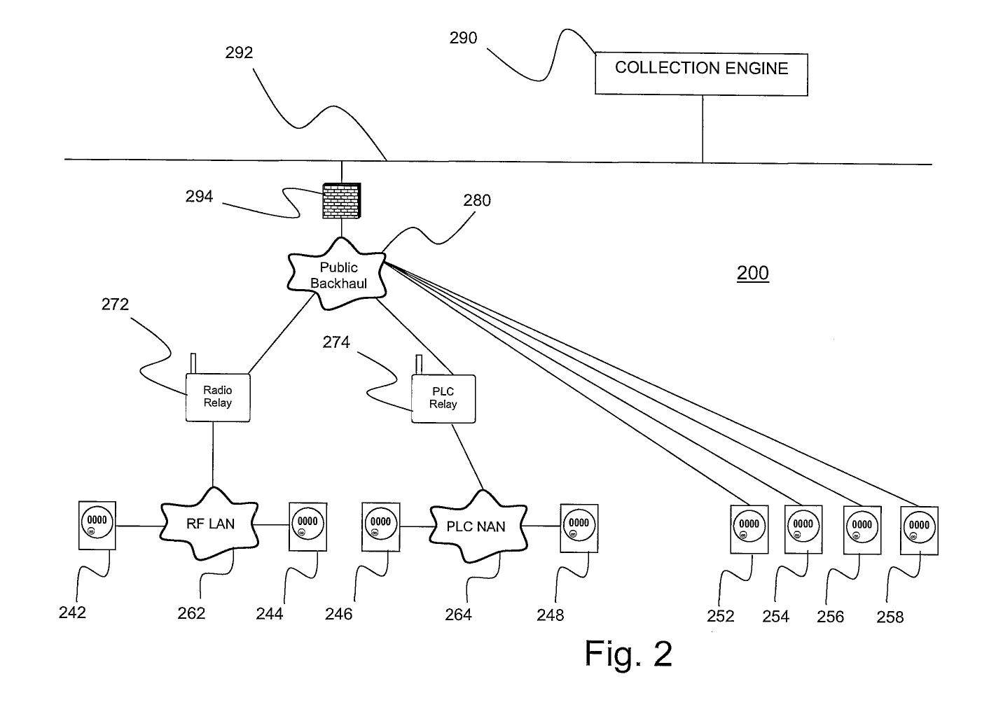

With particular reference to present FIG. 2, there is illustrated a block diagram overview of an exemplary Advanced Metering System (AMS) generally 200 in which software-defined communications units constructed in accordance with the presently disclosed subject matter may be advantageously employed. Advanced Metering System (AMS) 200 is designed per the present example to be a comprehensive system for providing advanced metering information and applications to utilities and supporting the downlink channel for Load Control, Demand Response and other Distribution Automation applications. AMS 200 may be built around current industry standard protocols and transports as well as future developed protocols and transport, i.e., communications, mechanisms.

Major components of the presently illustrated exemplary embodiment of AMS 200 may include such as meters 242, 244, 246, 248, 222, 224, 226, 228; one or more radio networks including RF local area network (RF LAN) 262 and accompanying Radio Relay 272 and power line communications neighborhood area network (PLC NAN) 264 and accompanying PLC Relay 274; an IP based Public Backhaul 280; and a Collection Engine generally 290. Collection Engine 290 generally controls the collection of data over the network. Much generally collected data relates to utility consumption such as data collected by meters 242, 244, 246, 248, 222, 224, 226, 228. Other exemplary components within representative AMS 200 may include a utility LAN 292 and firewall 294 through which communications signals to and from Collection Engine 290 may be transported from and to meters 242, 244, 246, 248, 222, 224, 226, 228 or other devices including, but not limited to, Radio Relay 272 and PLC Relay 274.

AMS 200 may be configured so as to be transportation agnostic or transparent, such that meters 242, 244, 246, 248, 222, 224, 226, 228 may be interrogated using Collection Engine 290 regardless of what network infrastructure exists in between. Moreover, due to such transparency, the representative meters may also alternatively respond to Collection Engine 290 in the same manner

In accordance with the presently disclosed subject matter, certain of the disparate and asymmetrical network substrates may be accommodated by the provision of a software-defined communications unit as previously described with reference to FIG. 1. In accordance with an exemplary configuration, Transmission Control Protocol/Internet Protocol (TCP/IP) may be employed in some embodiments and may involve the use of radio frequency transmission as through RF LAN 262 via Radio Relay 272 to transport such TCP/IP communications. It should be appreciated that TCP/IP is not the only such low-level transport layer protocol available and that other protocols such as User Datagram Protocol (UDP) may be used. All such variations are intended as coming within the scope of the presently disclosed subject matter.

An important aspect of the presently disclosed technology resides in the fact that it is not necessary to know beforehand with which of the network substrates (i.e., the RF layers represented by radio relay 272, RF LAN 262, and their associated exemplary metrology units 242, 244 or the PLC layers represented by PLC relay 274 and its associated PLC NAN and metrology units 246, 258) a metrology device incorporating the presently disclosed subject matter will be associated. Further, it is not necessary to know beforehand any particular operational aspects of the radio and PLC systems because the present use of a software-defined communications unit advantageously allows for installation of so provisioned equipment in any present AMS environment as well as any future-developed such environment.

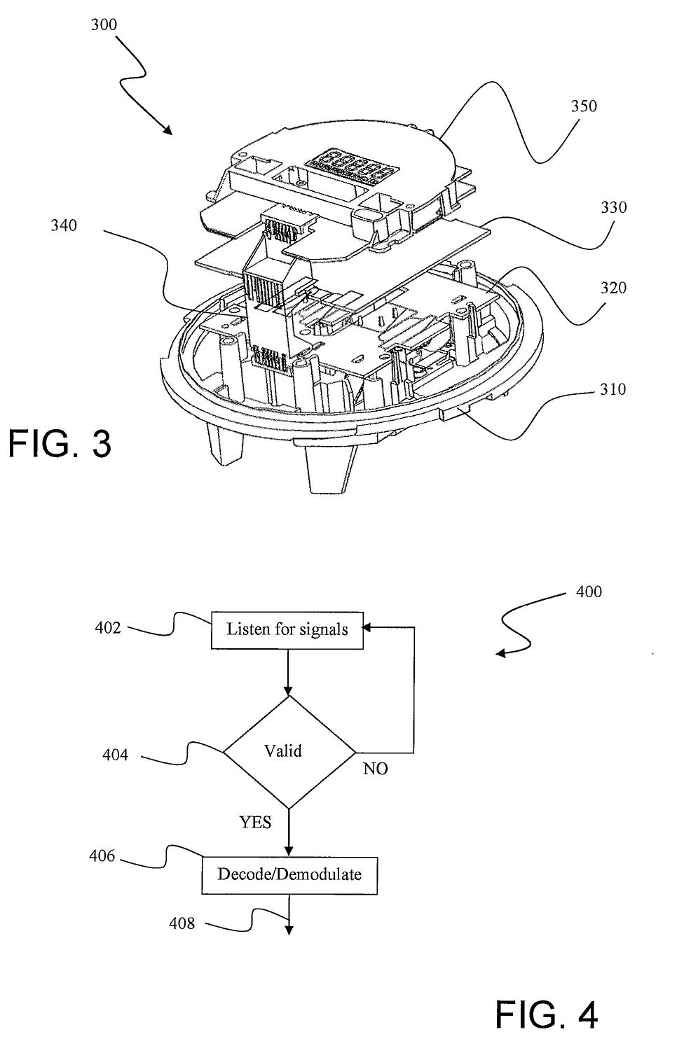

With reference to present FIG. 3, there is illustrated a top oblique view of an exemplary and representative utility meter 300 incorporating a software-defined communications unit in accordance with the presently disclosed technology. As may be seen from FIG. 3, exemplary utility meter 300 may include a base member 310 to which is attached a first printed circuit board (PCB) 320 that may correspond to a Metrology Printed Wiring Board (PWB). Connector 340 may be attached to connector traces on an edge portion of PCB 320. In a similar manner, a Communication Unit constructed in accordance with presently disclosed technology corresponding to a PCB 330 may be plugged into a second position slot in connector 340. Finally, a PCB 350 supporting a representative Display Board for utility meter 300 may be plugged into a third position (or portion) slot in representative connector 340.

Each of the several slot portions or positions of the representative connector 340 may provide electrical connections and/or support for the PCB plugged into such slot. The exemplary utility meter 300, once assembled, may be protected by placement of a glass cover or equivalent (not shown) over the three PCB's and into sealing engagement with the utility meter base 310. Those of ordinary skill in the art will appreciate that the representative meter generally 300 is merely an example of a meter with which the presently disclosed subject matter may be practiced, which subject matter generally is not restricted to use with electricity meters per se nor particular configurations thereof. Exemplary utility meter 300 may also be provided in a single board configuration where all of the metrology and communications components are mounted on a single PCB.

Referring to FIG. 4, there is illustrated a flow chart 400 illustrating a presently disclosed exemplary method by which the presently disclosed subject matter may receive and decode messages. In accordance with the presently disclosed subject matter, in step 402, one or more transceivers that are fully compatible with multiple wireless and power line communications standards and protocols simultaneously listen for signals using multiple different modulation techniques. If a signal is heard, determination is made (step 404) as to whether the signal is valid. In other words, it is determined whether the signal is one that the one or more transceivers is capable of demodulating. In accordance with the presently disclosed subject matter, the validity of the signal may be determined based on identification of a valid preamble portion of the received signal as previously described herein above. Once a valid signal is detected (step 404), the received signal may be decoded and demodulated (step 406). The decoded and demodulated signal may be presented on an output line at step 408 for further use.

As should be readily apparent, multiple advantages in addition to those already noted above may be obtained through the use of the presently disclosed technology. For example, initial installation cost may be greatly reduced as no additional costs are involved with trying to anticipate the best technology to deploy according to the topology. Communication reliability is greatly improved. Physical layer diversities allow the best efficiency packet routing solutions to reach a high level of connectivity independently of the network topology. Levels of connectivity on the order of 99.999% are often sought and made available through the use of the presently disclosed technology. Latency is greatly improved. Dual physical diversity gives the network layer the chance to choose the best physical interface to reduce hops and latency. Such arrangements are particularly suited in case of long distance networks where RF line-of-sight devices provide opportunity to improve speed performances compared to PLC long-range communication.

While the presently disclosed subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations, and/or additions to the presently disclosed subject matter as would be readily apparent to one of ordinary skill in the art.

What is claimed is:

1. A communications unit, comprising:
a protocol-transparent front end module, said front end module comprising a multi-band antenna system, a radio frequency (RF) receiver, and an RF transmitter;
a transceiver coupled to said front end module; and
a baseband signal processor coupled to said transceiver;
wherein said transceiver and said signal processor are configured to cooperate with said front end module so as to simultaneously listen for transmitted signals by using multiple different modulation techniques and to behave as a single protocol receiver once a valid transmitted signal is detected.

2. A communications unit is in claim 1, further comprising a power line communications (PLC) module associated with said front end module, wherein said transceiver and said signal processor are further configured to provide dual simultaneous concurrent RF and PLC communications.

3. A communications unit as in claim 2, wherein said transceiver and said signal processor are further configured to provide bridged communications between an RF network and a PLC network.

4. A communications unit as in claim 1, wherein said transceiver and said signal processor are configured to cooperate with said front end module to simultaneously listen for at least two different modulation techniques.

5. A communications unit as in claim 4, wherein said transceiver and said baseband signal processor are programmable, whereby said receiver may be programmed to receive alternative additional transmission frequencies and modulation protocols.

6. A communications unit as in claim 5, wherein said transceiver comprises a software implementation with a digital I and Q interface.

7. An advanced metering system (AMS), comprising:
a collection engine;
a plurality of endpoint devices, each respectively including a communications unit; and
at least one network configured to provide communications between said collection engine and said plurality of endpoint devices;
wherein said communications unit included with each endpoint device is configured to simultaneously listen for signals transmitted using multiple different modulation techniques and to behave as a single protocol receiver once a valid signal is detected.

8. An advanced metering system (AMS) as in claim 7, further comprising:
a second network; and
a power line communications (PLC) module associated with said communication unit included with each endpoint device;
wherein said at least one network is a radio frequency (RF) network;
said second network is configured for communications as a power line communication (PLC) network; and
said communication unit is further configured to provide dual simultaneous concurrent RF and PLC communications.

9. An advanced metering system (AMS) as in claim 8, wherein said communication unit is further configured to provide bridged communications between said RF network and said PLC network.

10. An advanced metering system (AMS) as in claim 9, wherein said communication unit is programmable, whereby said receiver may be programmed to receive alternative additional transmission frequencies and modulation protocols.

11. A utility meter, comprising:
a housing, said housing comprising a base and a removable cover;
metrology circuitry mounted within said housing; and
a communications unit mounted within said housing;
wherein said communications unit comprises a protocol-transparent front end module including a multi-band antenna system, a radio frequency (RF) receiver, and an RF transmitter, a transceiver coupled to said front end module, and a baseband signal processor coupled to said transceiver; and
said transceiver and said signal processor are configured to cooperate with said front end module to simultaneously listen for transmitted signals by using multiple different modulation techniques and to behave as a single protocol receiver once a valid signal is detected.

12. A utility meter as in claim 11, further comprising a power line communications (PLC) module associated with said front end module, wherein said transceiver and said signal processor are further configured to provide dual simultaneous concurrent RF and PLC communications.

13. A utility meter as in claim 12, wherein said transceiver and said signal processor are further configured to provide bridged communications between an RF network and a PLC network.

14. A utility meter as in claim 11, wherein said transceiver and said signal processor are configured to cooperate with said front end module to simultaneously listen for at least two different modulation techniques.

15. A utility meter as in claim 14, wherein said transceiver and said baseband signal processor are programmable, whereby said receiver may be programmed to receive alternative additional transmission frequencies and modulation protocols.

16. A utility meter as in claim 11, wherein said metrology circuitry and said communications unit are co-located on a common printed circuit board (PCB).

17. A utility meter as in claim 11, wherein said communications unit is coupled to said metrology circuitry.

18. A method, comprising:
simultaneously listening for signals transmitted using multiple different protocols;
detecting a valid signal based received signals; and
decoding and demodulating the received signal based on a detected valid signal.

19. A method as in claim 18, wherein detecting comprises detecting a valid preamble signal.

20. A method as in claim 18, wherein such method is used to operate a communications unit.

21. A method as in claim 20, wherein such method is used to operate a plurality of communications units that are respectively associated with utility meters for use in an advanced metering system infrastructure.
